(19) United States
(12) Patent Application Publication
(10) Pub. No.: US 2013/0335192 A1
(43) Pub. Date: Dec. 19, 2013

(54) CONTROL DEVICE FOR PROTECTIVE DOOR

(71) Applicant: HON HAI PRECISION INDUSTRY CO., LTD., New Taipei (TW)

(72) Inventor: CHUN-SHENG CHEN, New Taipei (TW)

(73) Assignee: HON HAI PRECISION INDUSTRY CO., LTD., New Taipei (TW)

(21) Appl. No.: 13/684,625

(22) Filed: Nov. 26, 2012

(30) Foreign Application Priority Data
Jun. 15, 2012 (CN) 2012101980830

(51) Int. Cl. G05B 1/01

(52) U.S. Cl. CPC G05B 1/01
USPC 340/5.6

(57) ABSTRACT

A control device is used to open and close a protective door of an electronic device. The control device includes a control chip, a microcontroller, a driving circuit, and a motor. The control chip outputs control signals to the microcontroller, according to instructions from an operating system of the electronic device. The microcontroller controls the driving circuit to drive the motor according to the control signals, and the motor rotates to open or close the protective door.

### BACKGROUND

1. Technical Field

The present disclosure relates to control devices, and more particularly to a control device for a protective door.

2. Description of Related Art

For convenience, optical disc drives (ODDs), universal serial bus (USB) ports, headphone jacks, and microphone interfaces are positioned on a front panel of a computer chassis. In order to prevent dust buildup on the ODDs, the USB ports, the headphone jacks, and the microphone interfaces, a protective door is employed. However, most protective doors need to be manually opened and closed and this may be an inconvenience.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a circuit diagram of a control device in accordance with an embodiment of the present disclosure.

FIG. 2 is a schematic view of an electronic device with a protective door controlled by the control device of FIG. 1.

FIG. 3 is similar to FIG. 2, but showing the protective door closed.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references can mean “at least one”.

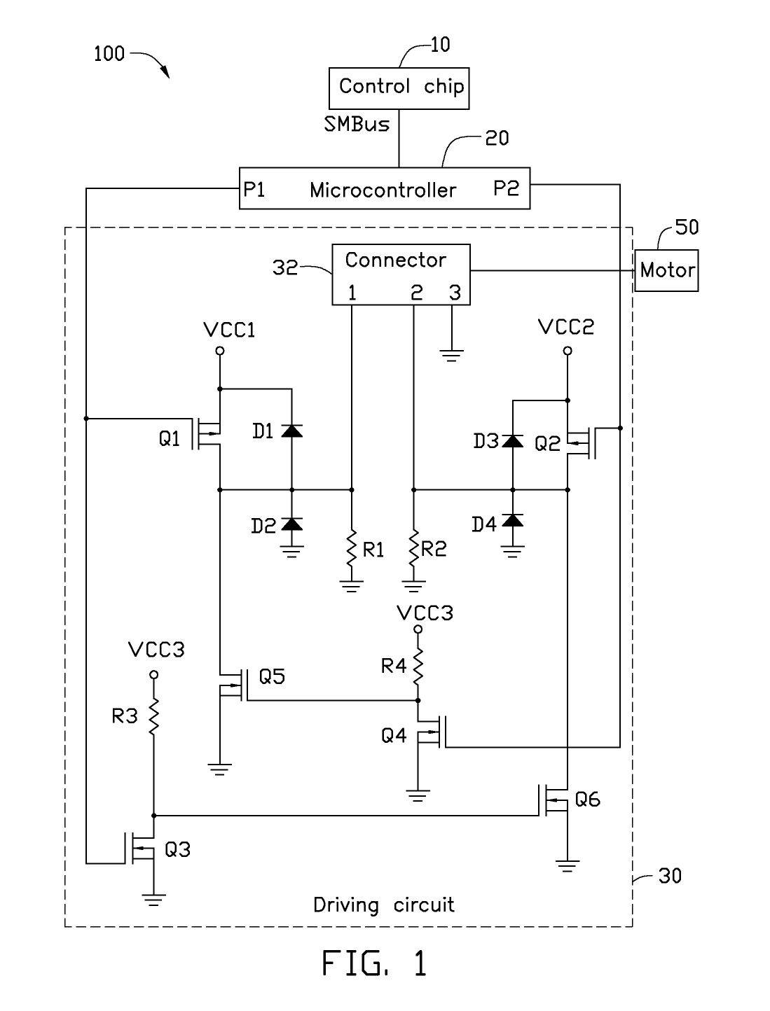

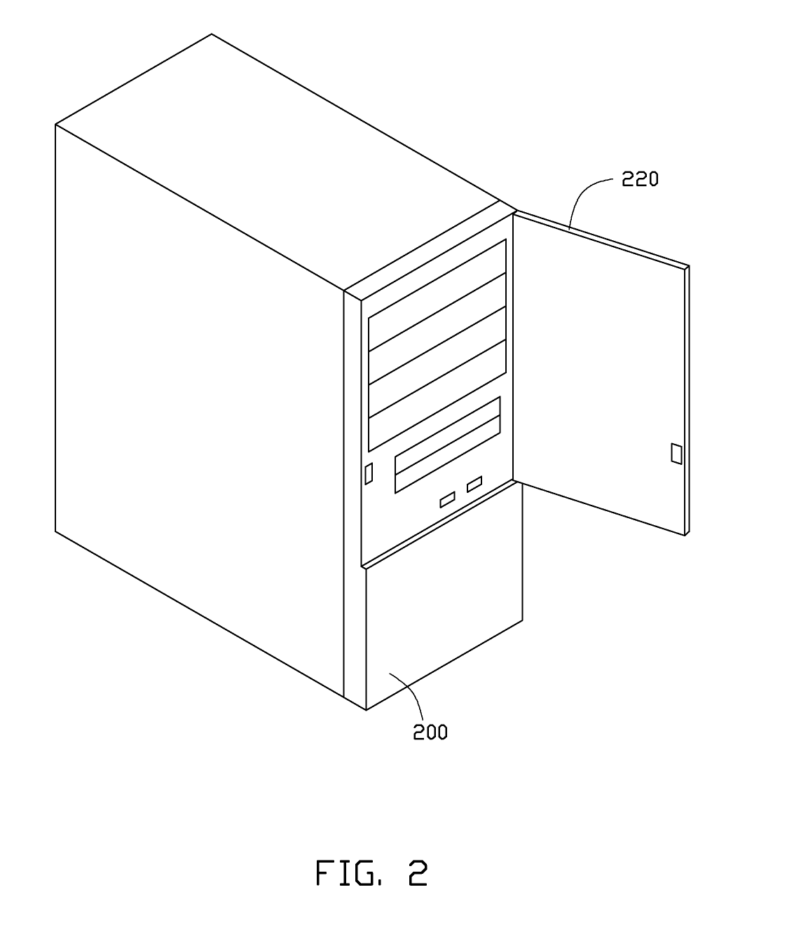

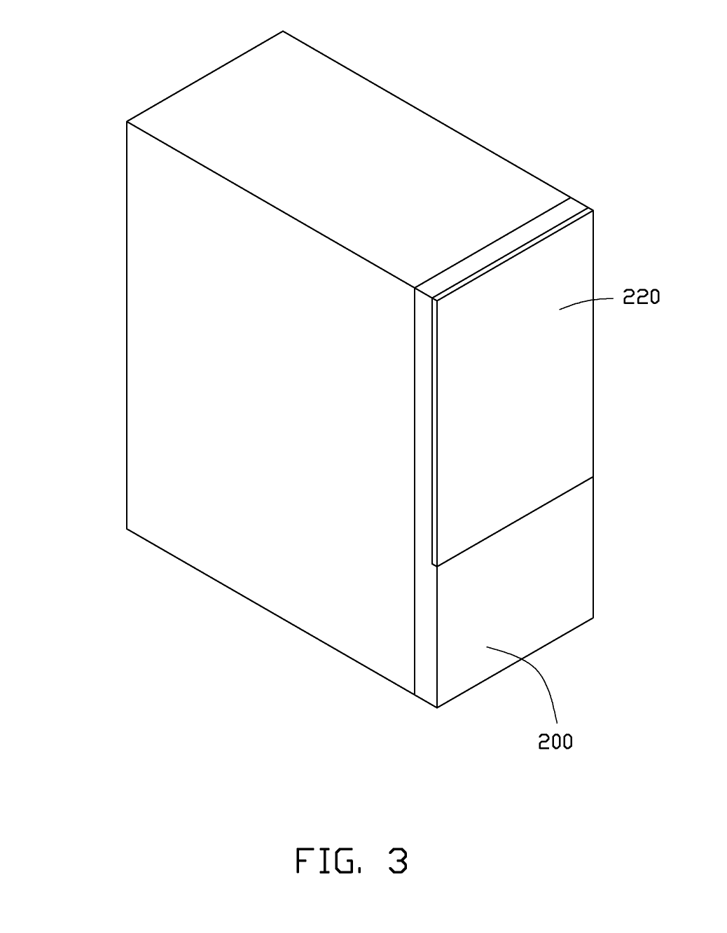

FIGS. 1 to 3 show an embodiment of a control device 100. The control device 100 is used to control the opening and closing of a protective door 220 of an electronic device 200, such as a computer chassis. The control device 100 includes a control chip 10, a microcontroller 20, a driving circuit 30, and a motor 50. The microcontroller 20 is connected to the control chip 10, and connected to the motor 50 through the driving circuit 30. The control chip 10 outputs control signals to the microcontroller 20, according to an opening instruction or a closing instruction received from an operating system of the electronic device 200. The opening instruction and the closing instruction are inputted into the operating system by a user. The microcontroller 20 controls the driving circuit 30 to drive the motor 50 according to the control signals. The motor 50 rotates to open or close the protective door 220. In one embodiment, the control chip 10 communicates with the microcontroller 20 though a system management bus SMBus. The control device 100 is assembled in the electronic device 200.

The driving circuit 30 includes six electronic switches Q1, Q2, Q3, Q4, Q5, and Q6, four diodes D1, D2, D3, and D4, four resistors R1, R2, R3, and R4, and a connector 32. Each of the electronic switches Q1-Q6 includes a first terminal, a second terminal, and a third terminal. The first terminal of the electronic switch Q1 is connected to a first pin P1 of the microcontroller 20. The second terminal of the electronic switch Q1 is connected to a first power supply VCC1. The first terminal of the electronic switch Q2 is connected to a second pin P2 of the microcontroller 20. The second terminal of the electronic switch Q2 is connected to a second power supply VCC2. The first terminal of the electronic switch Q3 is connected to the first pin P1 of the microcontroller 20. The second terminal of the electronic switch Q3 is connected to a third power supply VCC3 through the resistor R3. The first terminal of the electronic switch Q4 is connected to the second pin P2 of the microcontroller 20. The second terminal of the electronic switch Q4 is connected to the third power supply VCC3 through the resistor R4. The first terminal of the electronic switch Q5 is connected to the second terminal of the electronic switch Q4. The second terminal of the electronic switch Q5 is connected to the third terminal of the electronic switch Q1. The first terminal of the electronic switch Q6 is connected to the second terminal of the electronic switch Q3. The second terminal of the electronic switch Q6 is connected to the third terminal of the electronic switch Q2. All the third terminals of the electronic switches Q3-Q6 are grounded.

Each of the diodes D1-D4 includes an anode and a cathode. The anode of the diode D1 is connected to the second terminal of the electronic switch Q1. The cathode of the diode D1 is connected to the third terminal of the electronic switch Q1. The anode of the diode D2 is grounded. The cathode of the diode D2 is connected to the anode of the diode D1. The anode of the diode D3 is connected to the second terminal of the electronic switch Q2. The cathode of the diode D3 is connected to the third terminal of the electronic switch Q2. The anode of the diode D4 is grounded. The cathode of the diode D4 is connected to the anode of the diode D3.

The connector 32 includes three pins 1-3. Pin 1 of the connector 32 is connected to the third terminal of the electronic switch Q1, and grounded through the resistor R1. Pin 2 of the connector 32 is connected to the third terminal of the electronic switch Q2, and grounded through the resistor R2. Pin 3 of the connector 32 is grounded. The connector 32 is also connected to the motor 50.

When the control chip 10 receives an opening instruction from the operating system of the electronic device 200, the control chip 10 outputs a first control signal to the microcontroller 20. The first pin P1 of the microcontroller 20 thus outputs a low level signal to the first terminals of the electronic switches Q1 and Q3, and the second pin P2 of the microcontroller 20 outputs a high level signal to the first terminals of the electronic switches Q2 and Q4. The electronic switches Q1 and Q4 are turned on. The electronic switches Q2 and Q3 are turned off. The first terminal of the electronic switch Q5 receives a low level signal from the second terminal of the electronic switch Q4. The electronic switch Q5 is turned off. The first terminal of the electronic switch Q6 receives a high level signal from the second terminal of the electronic switch Q3. The electronic switch Q6 is turned on. Pin 1 of the connector 32 is thus connected to the first power supply VCC1 through the electronic switch Q1, and outputs a first power supply VCC1 to the motor 50. Pin 2 of the connector 32 is grounded through the electronic switch Q6. At this moment, current from the first power supply VCC1 flows into the motor 50 through pin 1 of the connector 32, and then to ground through pin 2 of the connector 32 and the electronic switch Q6. The motor 50 rotates forward to open the protective door 220.

When the control chip 10 receives a closing instruction from the operating system of the electronic device 200, the control chip 10 outputs a second control signal to the microcontroller 20. The first pin P1 of the microcontroller 20 thus outputs a high level signal to the first terminals of the electronic switches Q1 and Q3, and the second pin P2 of the microcontroller 20 outputs a low level signal to the first terminals of the electronic switches Q2 and Q4. The electronic switches Q1 and Q4 are turned off. The electronic switches Q2 and Q3 are turned on. The first terminal of the electronic switch Q5 receives a high level signal from the second terminal of the electronic switch Q4. The electronic switch Q5 is turned on. The first terminal of the electronic switch Q6 receives a low level signal from the second terminal of the electronic switch Q3. The electronic switch Q6 is turned off. Pin 2 of the connector 32 is connected to the second power supply VCC2 through the electronic switch Q2, and outputs the second power supply VCC2 to the motor 50. Pin 1 of the connector 32 is grounded through the electronic switch Q5. At this moment, current from the second power supply VCC2 flows into the motor 50 through pin 2 of the connector 32, and then to ground through pin 1 of the connector 32 and the electronic switch Q5. The motor 50 rotates in reverse to close the protective door 220.

In the embodiment, each of the electronic switches Q1 and Q2 is a p-channel metal-oxide semiconductor field-effect transistor (PMOSFET). The first terminal, the second terminal, and the third terminal of each of the electronic switches Q1 and Q2 are respectively a gate, a source, and a drain of the PMOSFET. Each of the electronic switches Q3-Q6 is an n-channel semiconductor field-effect transistor (NMOSFET). The first terminal, the second terminal, and the third terminal of each of the electronic switches Q3-Q6 are respectively a gate, a drain, and a source of the NMOSFET.

In other embodiments, each of the electronic switches Q1 and Q2 may be a pnp bipolar junction transistor, or other electronic switch having similar functions. Each of the electronic switches Q3-Q6 may be an npn bipolar junction transistor, or other electronic switch having similar functions.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A control device to open and close a protective door of an electronic device, the control device comprising:
a control chip to output control signals according to an opening instruction or a closing instruction received from an operating system of the electronic device;
a microcontroller connected to the control chip to receive the control signals;
a driving circuit connected to the microcontroller; and
a motor connected to the driving circuit;
wherein the microcontroller controls the driving circuit to drive the motor according to the control signals, and the motor rotates to open or close the protective door.

2. The control device of claim 1, wherein the microcontroller comprises a first pin and a second pin, and the driving circuit comprises:
a first resistor and a second resistor;
a connector connected to the motor, the connector comprising a first pin and a second pin;
a first electronic switch comprising a first terminal connected to the first pin of the microcontroller, a second terminal connected to a first power supply, and a third terminal connected to the first pin of the connector;
a second electronic switch comprising a first terminal connected to the second pin of the microcontroller, a second terminal connected to a second power supply, and a third terminal connected to the second pin of the connector;
a third electronic switch comprising a first terminal connected to the first pin of the microcontroller, a second terminal connected to a third power supply through the first resistor, and a third terminal grounded;
a fourth electronic switch comprising a first terminal connected to the second pin of the microcontroller, a second terminal connected to the third power supply through the second resistor, and a third terminal grounded;
a fifth electronic switch comprising a first terminal connected to the second terminal of the fourth electronic switch, a second terminal connected to the third terminal of the first electronic switch, and a third terminal grounded; and
a sixth electronic switch comprising a first terminal connected to the second terminal of the third electronic switch, a second terminal connected to the third terminal of the second electronic switch, and a third terminal grounded.

3. The control device of claim 2, wherein in response to the control chip receiving the opening instruction from the operating system of the electronic device, the control chip outputs a first control signal to the microcontroller;
the first pin of the microcontroller outputs a first signal to the first terminals of the first and third electronic switches, and the second pin of the microcontroller outputs a second signal to the first terminals of the second and fourth electronic switches;
the first and fourth electronic switches are turned on, the second and third electronic switches are turned off, the fifth electronic switch is turned off, and the sixth electronic switch is turned on;
the first pin of the connector is connected to the first power supply through the first electronic switch, and outputs the first power supply to the motor, the second pin of the connector is grounded through the sixth electronic switch; and
current from the first power supply flows into the motor through the first pin of the connector, and then to ground through the second pin of the connector and the sixth electronic switch, the motor rotates forward to open the protective door.

4. The control device of claim 3, wherein in response to the control chip receiving the closing instruction from the operating system of the electronic device, the control chip outputs a second control signal to the microcontroller;
the first pin of the microcontroller outputs a third signal to the first terminals of the first and third electronic switches, and the second pin of the microcontroller outputs a fourth signal to the first terminals of the second and fourth electronic switches;
the first and fourth electronic switches are turned off, the second and third electronic switches are turned on, the fifth electronic switch is turned on, and the sixth electronic switch is turned off;
the first pin of the connector is grounded through the fifth electronic switch, the second pin of the connector is connected to the second power supply through the second electronic switch, and outputs the second power supply to the motor; and
current from the second power supply flows into the motor from the second pin of the connector, and then to ground through the first pin of the connector and the fifth electronic switch, the motor rotates in reverse to close the protective door.

5. The control device of claim 4, wherein each of the first and second electronic switches is a p-channel metal-oxide semiconductor field-effect transistor (PMOSFET), the first terminal, the second terminal, and the third terminal of each of the first and second electronic switches are a gate, a source, and a drain of the PMOSFET.

6. The control device of claim 4, wherein each of the third, fourth, fifth and sixth electronic switches is an n-channel semiconductor field-effect transistor (NMOSFET), the first terminal, the second terminal, and the third terminal of each of the third, fourth, fifth and sixth electronic switches are a gate, a drain, and a source of the NMOSFET.

7. The control device of claim 2, wherein the driving circuit further comprises:
a third resistor and a fourth resistor;
a first diode comprising an anode connected to the first pin of the connector and grounded through the third resistor, and a cathode connected to the first power supply;
a second diode comprising an anode grounded, and a cathode connected to the anode of the first diode;
a third diode comprising an anode connected to the second pin of the connector and grounded through the fourth resistor, and a cathode connected to the second power supply; and
a fourth diode comprising an anode grounded, and a cathode connected to the anode of the third diode.

8. The control device of claim 1, wherein the control chip communicates with the microcontroller though a system management bus.
